(19) United States
(12) Patent Application Publication
(10) Pub. No.: US 2013/0001341 A1
(43) Pub. Date: Jan. 3, 2013

(54) DRIVING DEVICE FOR A GRINDER, AND CORRESPONDING GRINDER

(75) Inventor: Fabrice Lessard, Cambrai (FR)

(73) Assignee: Compagnie Engrenages Et Reducteurs - Messian - Durand, Cambrai (FR)

(21) Appl. No.: 13/536,457

(22) Filed: Jun. 28, 2012

(30) Foreign Application Priority Data
Jun. 29, 2011 (FR) 11 5580

(51) Int. Cl. B02C 25/00; B02C 4/12; F16H 37/06

(52) U.S. Cl. 241/36; 74/661

(57) ABSTRACT

A driving device for a grinder comprises a toothed ring, and at least two driving assemblies for the toothed ring. Each driving assembly comprises an electric motor and a reduction gear unit. The driving device comprises safety means suitable for preventing the starting of all the driving assemblies when at least one driving assembly is unavailable.

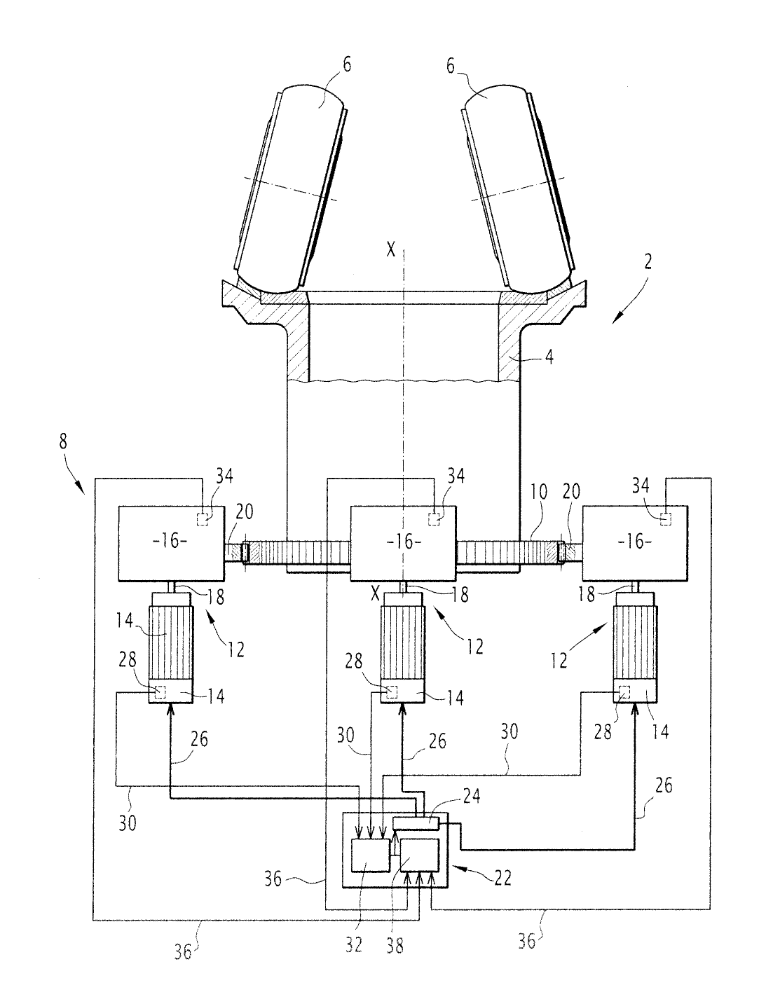

This application claims priority under 35 U.S.C. §119 to French Patent Application No. 1155800, filed on Jun. 29, 2011. The contents of this application are incorporated by reference in their entirety.

The present invention relates to a driving device for a grinder, notably for a vertical grinder, comprising
a toothed ring,
at least two assemblies for driving the toothed ring,

each driving assembly comprising
an electric motor and
a reduction gear unit.

Driving devices for grinders of this type are known.

However, these devices only have limited safety, given that during a failure of an electric motor or of a reduction gear unit, the operator may attempt to operate the driving device. In this case, either the remaining electric motors are used beyond their rated power or the force exerted on the components of the reduction gear unit or of the toothed ring is located beyond the foreseen forces.

The object of the invention is to provide a driving device for a grinder, which has increased safety and this with simple means.

For this purpose, the object of the invention is a driving device of the indicated type, characterized in that the driving device comprises a safety means suitable for preventing the starting of all the driving assemblies when at least one driving assembly is unavailable.

According to embodiments, the driving device comprises one or several of the following features:
the driving device includes at least three driving assemblies;
the safety means include failure detection means for detecting a failure of each driving assembly and control means suitable for preventing the starting of all the electric motors in response to a failure detection by the failure detection means;
the failure detection means include for each electric motor, an electric motor failure sensor;
the failure detection means include for each reduction gear unit, a reduction gear unit failure sensor;
at least two driving assemblies, and preferably all the driving assemblies are identical.

The object of the invention is also a grinder, comprising:
a grinding table,
at least one grinding roller, and
and a driving device,

characterized in that the driving device is a driving device as described above.

The invention will be better understood upon reading the following description, only given as an example and made with reference to the appended drawing, wherein the single FIGURE shows a grinder comprising a driving device according to the invention.

The single FIGURE schematically shows a grinder according to the invention designated by the general reference 2.

The grinder 2 is a vertical grinder, which comprises a grinding table 4, several grinding rollers 6 and a driving device 8 for driving the grinding table 4 into rotation. The grinding table 4 is mobile in rotation around a vertical axis X-X.

The driving device 8 comprises a toothed ring 10 fixed in rotation around the axis X-X to the grinding table 4.

The driving device 8 also comprises assemblies 12 for driving the toothed ring 10. In this case, the driving device 8 comprises three driving assemblies 12.

It should be noted that the grinder 2 and the driving device 8 do not include other means for driving the toothed ring 10 or the grinding table 4. The means for driving the toothed ring 10 into rotation around the axis X-X are therefore formed by the driving assemblies 12.

Preferably, at least two, and notably all the driving assemblies 12 are identical.

Each driving assembly 12 comprises an electric motor 14 as well as a reduction gear unit 16. The electric motor 14 comprises an output shaft 18, which is connected to an input shaft not shown of the reduction gear unit 16. The reduction gear unit 16 comprises an output pinion 20, which directly meshes with the toothed ring 10.

The driving device 8 also comprises a control device 22, comprising a power supply module 24, which is connected through a power supply line 26 to each of the electric motors 14. Thus, the power supply module 24 is suitable for starting the electric motors 14.

The driving device 8 also comprises safety means suitable for preventing the turning-on or starting of all the driving assemblies 12 when at least one driving assembly 12 is unavailable or faulty. In this case, the safety means include failure detection means suitable for detecting a failure of each driving assembly 12. The safety means also include a control means suitable for preventing the turning-on or starting of all the electric motors 14 in response to a failure detection by the failure detection means.

The failure detection means comprise means for detecting failure of a motor, which are provided for each electric motor 28, suitable for detecting a failure of the associated electric motor 14 on the one hand, and a signal line 30 on the other hand. The motor failure detection means further include a module 32 for evaluating the failure condition of the electric motors 14. Each signal line 30 is connected to this evaluation module 32. The evaluation module 32 is suitable for detecting the failure condition of one or several electric motors 14 via the electric motor failure sensors 28 and the signal lines 30 and is suitable for emitting a motor failure signal to the power supply module 24. The power supply module 24 is suitable for preventing powering of all the electric motors 14, as a response to this signal.

The failure detection means comprise reduction gear unit failure detection means, which are provided, for each reduction gear unit 16, with a reduction gear unit failure sensor 34 suitable for detecting a failure of the associated reduction gear unit 16 on the one hand, and with a signal line 36 on the other hand. The reduction gear unit failure detection means include a module 38 for evaluating the failure condition of the reduction gear units 16. The evaluation module 38 is suitable for detecting the failure condition of one or several reduction gear units 16 via reduction gear unit failure sensors 34 and the signal lines 32 and is suitable for emitting a reduction gear unit failure signal to the power supply module 24. The power supply module 24 is suitable for preventing the powering of all the electric motors 14 in response to this signal.

The invention operates in the following way.

When none of the motor failure sensors 34, and none of the reduction gear unit failure sensors 28 detect any failure of an electric motor 14 or of a reduction gear unit 16, modules 32 and 38 do not emit any failure signal and the power supply module 24 allows the starting of each electric motor 14.

When at least one of the motor failure 28 and reduction gear unit failure 34 sensors detects a failure of a motor or reduction gear unit, the relevant evaluation module 32 or 38 emits a failure signal to the power supply module 24, which, in response to this signal. blocks the turning-on or starting of each of the electric motors 14, so that upon failure of an electric motor 14 or of a reduction gear unit 16, none of the driving assemblies 12 are started. Thus, the use of the components outside their rated capacity is prevented in the case of a failure of a component.

The motor failure sensors 28 may for example be a current sensor indicating the presence or absence of current in the coils of the motor or a force or torque sensor indicating the presence or the absence of force at the output shaft 18.

Also, the reduction gear unit failure sensor 34 may be a force or torque sensor indicating the presence or the absence of force or of torque at a shaft of the reduction gear unit or of the output pinion 20.

The control device 22 may be applied by a computer, a PLC or any other means.

1. A driving device for a grinder, notably a vertical grinder, of the type comprising:
a toothed ring,
at least two driving assemblies for driving the toothed ring, each driving assembly comprising
an electric motor and
a reduction gear unit,
characterized in that the driving device comprises safety means suitable for preventing the starting of all the driving assemblies when at least one driving assembly is unavailable.

2. The driving device according to claim 1, characterized in that the driving device includes at least three driving assemblies.

3. The driving device according to claim 1, characterized in that the safety means include failure detection means suitable for detecting a failure of each driving assembly and a control means, suitable for preventing the starting of all the electric motors in response to a failure detection by the failure detection means.

4. The driving device according to claim 3, characterized in that the failure detection means include for each electric motor an electric motor failure sensor.

5. The driving device according to claim 3, characterized in that the failure detection means include for each reduction gear unit a reduction gear unit failure sensor.

6. The driving device according to claim 1, characterized in that at least two driving assemblies, and preferably all the driving assemblies are identical.

7. A grinder, of the type comprising
a grinding table,
at least one grinding roller, and
a driving device, characterized in that the driving device is a driving device according to claim 1.
